(19) United States
(12) Patent Application Publication
(10) Pub. No.: US 2022/0058758 A1
(43) Pub. Date: Feb. 24, 2022

(54) METHODS, COMPUTING PLATFORMS, AND STORAGE MEDIA IMPLEMENTED BY AN EXPERT DEVELOPMENT SYSTEM

(71) Applicant: SOCIETY OF CABLE TELECOMMUNICATIONS ENGINEERS INC., Exton, PA (US)

(72) Inventors: Jill Banks, Norristown, PA (US); Christopher Bastian, Glenmoore, PA (US); Margaret Bernroth, Gulph Mills, PA (US); Mark Dzuban, Elverson, PA (US); David Edmunds, Chester Springs, PA (US); Robin Fenton, Downingtown, PA (US)

(73) Assignee: SOCIETY OF CABLE TELECOMMUNICATIONS ENGINEERS INC.

(21) Appl. No.: 17/410,601

(22) Filed: Aug. 24, 2021

Related U.S. Application Data
(60) Provisional application No. 63/069,426, filed on Aug. 24, 2020.

(51) Int. Cl. G06Q 50/20; G06F 16/25; G06F 16/23; G06Q 10/10; G06Q 10/06; G06F 3/14; A63F 13/537; A63F 13/60

(52) U.S. Cl. CPC G06Q 50/2057; G06F 16/252; G06F 16/2365; A63F 13/60; G06Q 10/06375; G06F 3/14; A63F 13/537; G06Q 10/105

(57) ABSTRACT

Methods, computing platforms, and storage media implemented by an expert development system are disclosed. Exemplary implementations may: receive input from a plurality of sources; validate the set of employee data to yield validated data; store the validated data in a data warehouse; analyze the validated data to generate analyzed data; and generate one or more visualizations, based on the analyzed data, which is presented on a graphical user interface.

### CROSS-REFERENCE

This application claims the benefit of U.S. Provisional Patent Application No. 63/069,426 filed on Aug. 24, 2020, which is incorporated by reference as if fully set forth.

### FIELD OF THE DISCLOSURE

The present disclosure relates to methods, computing platforms, and storage media implemented by an expert development system.

### BACKGROUND

In any given industry, there may be training and development of individuals within a given workforce in order to develop skilled workers with in-depth knowledge. There is a need for a system that can aggregate data from disparate systems and analyze this data in order track measurable business results and benefits.

### SUMMARY

Generally, an expert development system may mange the lifecycle of data generated for a particular industry, and allow participating companies to reap the benefits of having this data gathered, tagged, stored, and analyzed (e.g., current metrics, recommendations, etc.). These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured implemented by an expert development system, in accordance with one or more implementations.

FIGS. 2A, 2B, and 2C illustrates a method implemented by an expert development system, in accordance with one or more implementations.

FIG. 3 is a schematic of the invention, showing method inputs, storage, analysis, and method outputs.

FIG. 4 is a functional flowchart of the invention, showing how data flows from input to output through the invention.

FIG. 5 illustrates individual employee competencies.

FIG. 6 is an example of an individual employee or corporate scorecard, showing for example course statistics, employee engagement, course completion rate, course pass rate, engagement level.

FIG. 7 is an example of a dashboard.

FIG. 8 is an example of a transcript, showing for example all of the courses the employee has completed, dates of starting and completing, class score, and class credits.

FIG. 9 is an example of a leaderboard, showing for example who has completed the most courses or certifications, who has attended the most events, and who has most utilized the website.

FIGS. 10A and 10B are an example diagram showing the results of data analysis according to one or more embodiments disclosed herein, such as alerts, reports, and dashboards including various visualizations.

FIG. 11 illustrates the four steps necessary for a company to realize its return on investing in learning and development.

FIG. 12 is an example of customized reports to corporate members, listing tangible returns on investment.

FIG. 13 is an example of customized reports to corporate members, listing executive summary information.

### DETAILED DESCRIPTION

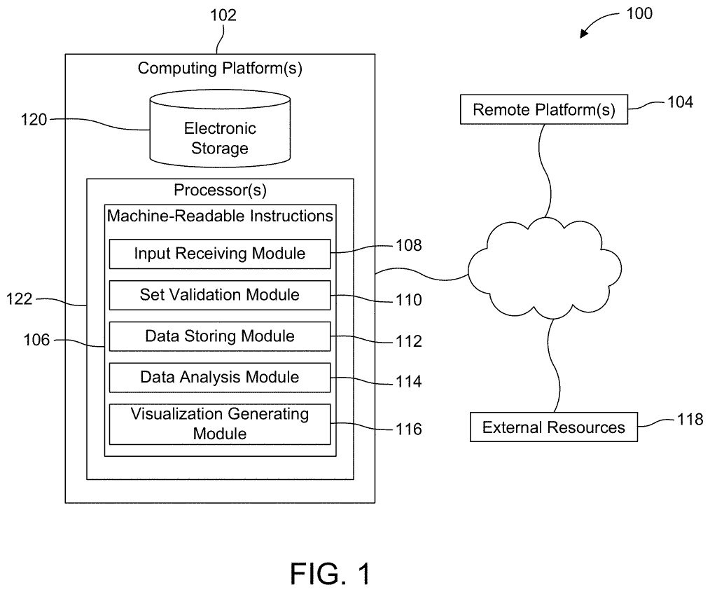

FIG. 1 illustrates an expert development system 100, in accordance with one or more implementations. In some implementations, system 100 may include one or more computing platforms 102. Computing platform(s) 102 may be configured to communicate with one or more remote platforms 104 according to a client/server architecture, a peer-to-peer architecture, and/or other architectures. Remote platform(s) 104 may be configured to communicate with other remote platforms via computing platform(s) 102 and/or according to a client/server architecture, a peer-to-peer architecture, and/or other architectures. Users may access system 100 via remote platform(s) 104.

Computing platform(s) 102 may be configured by machine-readable instructions 106. Machine-readable instructions 106 may include one or more instruction modules. The instruction modules may include computer program modules. The instruction modules may include one or more of input receiving module 108, set validation module 110, data storing module 112, data analysis module 114, visualization generating module 116, request receiving module 118, and/or other instruction modules.

Input receiving module 108 may be configured to receive input from a plurality of sources. The input may include employee data for each of a plurality of employees to yield a set of employee data. Each certification may be specific to a technical field and certifies that an individual has completed a set of courses and passed an examination of each of the set of courses thereby demonstrating the individual's mastery in the technical field and resulting in the individual receiving a certification. By way of non-limiting example, each certification may generate input including a list of certifications, a list of individuals and any certifications they have received, a list of individuals and a date they received any certification, a list of individuals and a progress in any certification, and a list of individuals and a date of any required recertification. By way of non-limiting example, the plurality of sources may include one or more chapters, courses, standards development organizations, conferences or expositions, memberships, foundations, cable and internet protocol games, certifications, websites, applications, leadership institutes, human resource databases and systems, and partner information.

Set validation module 110 may be configured to validate the set of employee data to yield validated data. Storing the validated data may further include reformatting all data to a standardized format. Analyzing the validated data may further include tagging the data, where each data may be multiple tags. Analyzing may further include tagging each employee of the plurality of employees with a set of competencies. Analyzing the validated data may further include tagging each employee of the plurality of employees with a gap assessment. Analyzing the validated data may further include calculating a return on investment that indicates how soon an individual or company will be paid back for investing in an activity or group of activities.

The employee data may include a transcript specific to a single employee and contains information from more than one source of the plurality of sources.

Data storing module 112 may be configured to store the validated data in a data warehouse.

Data analysis module 114 may be configured to analyze the validated data to generate analyzed data. By way of non-limiting example, the analyzing may be performed using one or more techniques, the one or more techniques including machine learning, statistical analysis, data mining, business objective analysis, return on investment analysis, or needs assessing. The analyzing may be performed by an analytics engine. The analyzing may be performed by an analytics engine. The analyzed data may further include employee performance in key areas.

The analyzed data may further include a score card. A report may be specific to one of the plurality of sources and includes competencies and recommendations determined based on the analyzed data. The analyzed data may include a leader board showing a ranked list of high performing employees of the plurality of employees. By way of non-limiting example, the analyzed data may include one or more alerts, reports, and dashboards.

Visualization generating module 116 may be configured to generate one or more visualizations, based on the analyzed data, which is presented on a graphical user interface. The graphical user interface may include at least one website or application for the expert development system. The website or application may generate input including information gathered from users or visitors of the website or application. By way of non-limiting example, the one or more visualizations may include charts, graphs, lists, spreadsheets, graphically arranged text, and animations.

Request receiving module 118 may be configured to receive a first request. The first request may include an indication of a first analysis and first visualization. The analyzing and generating one or more visualizations may be customized based on the first request.

In some implementations, each chapter may include a group of individuals in a geographic region. In some implementations, by way of non-limiting example, the members may meet on a regular basis to conduct training classes, practice technical skills, and socially network with other individuals in an industry. In some implementations, each chapter may collect information regarding each individual of the chapter. In some implementations, by way of non-limiting example, each chapter may generate input based on the collected information including individuals of the chapter, an active or inactive status of each individual, training activities conducted by the chapter, skills competitions conducted by the chapter, people who have presented at an activity at the chapter, and people who volunteers as a leader within the chapter. In some implementations, each course may include a training opportunity that individuals select to learn and master new technical skills.

In some implementations, by way of non-limiting example, each course may generate input including all courses created by an organization, student profiles, student names, student birthdates, student companies, student progress for each course, student performance evaluations, and student competencies. In some implementations, by way of non-limiting example, each standards development organization may develop, update, and promulgates standard and operating practices that speed up an introduction of innovative products to a market and expedite adoption and deployment in an industry. In some implementations, by way of non-limiting example, each standards development organization may generate input including all standards and operating practices created by the standards development organization, standards development organization member profiles, and standards development membership organization activities that contribute to creating the standards and operating practices. In some implementations, by way of non-limiting example, each conference or exposition may be a periodic industry gathering that showcases technical developments in an industry with presentations of technical papers, demonstrations of technologies and equipment, meetings for technical exchange, and social networking. In some implementations, by way of non-limiting example, each conference or exposition may generate input including attendees, exhibitors, sponsors, competition winners, and technical papers. In some implementations, each membership may include either an individual membership or a company membership.

In some implementations, the company membership may provide an enterprise license for the company's employees. In some implementations, by way of non-limiting example, the individual membership or the company membership may receive discounted pricing to training, standards related material, conferences, and membership only events. In some implementations, by way of non-limiting example, each membership may generate input including member name, member address, member company, member start date, member expiration date, and member exclusive events. In some implementations, each foundation may be a philanthropic organization that funds training of individuals who have financial hardship. In some implementations, by way of non-limiting example, each foundation may generate input including members of a foundation, members of management board of the foundation, and a list of individuals that have received funding from the foundation. In some implementations, each cable and IP game may be a learning and development tool wherein participants demonstrate learned skills and compete for recognition and prizes.

In some implementations, by way of non-limiting example, each cable and IP game may generate input including games offered over a period of time, each game a participant has played, and each score of each game a participant has played. In some implementations, each leadership institute may include a collaboration between industry and academic partners focused on developing leaders in industry. In some implementations, by way of non-limiting example, each leadership institute may generate input including institute attendees, institute topics, institute alumni, and institute professors and speakers. In some implementations, each human resource database and system may be a collection of information from a company's employees. In some implementations, by way of non-limiting example, each human resource database and system may generate input including employee information, individual information, employee competencies, individual competencies, employee achievements, individual achievements, employee transcripts, or individual transcripts. In some implementations, each partner may include a company that has access to the expert development system.

In some implementations, each partner may generate input including information unique to the company or organization. In some implementations, each partner may be categorized as either a skills-based partner or a standards based partner. In some implementations, by way of non-limiting example, each partner may be a telecommunications multi-system operator, a telecommunications equipment vendor, a telecommunications service vendor, or a standards contributor. In some implementations, the expert development system may include one or more computers. In some implementations, the graphics engine may be part of the analytics engine.

In some implementations, analyzed data may further include patterns or trends that are not determinable from a single source. In some implementations, each employee may be incentivized to achieve a higher score on a score card. In some implementations, by way of non-limiting example, the dashboard may show one or more visualizations for a period of time regarding one or more activities, one or more employees, or one or more corporations. In some implementations, by way of non-limiting example, the dashboard may show one or more visualizations for a period of time regarding one or more activities, one or more employees, or one or more corporations. In some implementations, each activity may be associated or displayed with a competency. In some implementations, by way of non-limiting example, a report may include information on a gap between competencies a company requires and competencies an employee possesses, and where the report further includes a method to fill the gap through training or other skills development.

In some implementations, a report may include a return-on-investment assessment summary. In some implementations, the leaderboard also may include information about the high performing employees. In some implementations, by way of non-limiting example, each employee data may include elements relating to at least one of learning and professional development, certifications, standards development, professional engagements, and teaching engagements.

In some implementations, computing platform(s) 102, remote platform(s) 104, and/or external resources 120 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 102, remote platform(s) 104, and/or external resources 120 may be operatively linked via some other communication media.

A given remote platform 104 may include one or more processors configured to execute computer program modules. The computer program modules may be configured to enable an expert or user associated with the given remote platform 104 to interface with system 100 and/or external resources 120, and/or provide other functionality attributed herein to remote platform(s) 104. By way of non-limiting example, a given remote platform 104 and/or a given computing platform 102 may include one or more of a server, a desktop computer, a laptop computer, a handheld computer, a tablet computing platform, a NetBook, a Smartphone, a gaming console, and/or other computing platforms.

External resources 120 may include sources of information outside of system 100, external entities participating with system 100, and/or other resources. In some implementations, some or all of the functionality attributed herein to external resources 120 may be provided by resources included in system 100.

Computing platform(s) 102 may include electronic storage 122, one or more processors 124, and/or other components. Computing platform(s) 102 may include communication lines, or ports to enable the exchange of information with a network and/or other computing platforms. Illustration of computing platform(s) 102 in FIG. 1 is not intended to be limiting. Computing platform(s) 102 may include a plurality of hardware, software, and/or firmware components operating together to provide the functionality attributed herein to computing platform(s) 102. For example, computing platform(s) 102 may be implemented by a cloud of computing platforms operating together as computing platform(s) 102.

Electronic storage 122 may comprise non-transitory storage media that electronically stores information. The electronic storage media of electronic storage 122 may include one or both of system storage that is provided integrally (i.e., substantially non-removable) with computing platform(s) 102 and/or removable storage that is removably connectable to computing platform(s) 102 via, for example, a port (e.g., a USB port, a firewire port, etc.) or a drive (e.g., a disk drive, etc.). Electronic storage 122 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 122 may include one or more virtual storage resources (e.g., cloud storage, a virtual private network, and/or other virtual storage resources). Electronic storage 122 may store software algorithms, information determined by processor(s) 124, information received from computing platform(s) 102, information received from remote platform(s) 104, and/or other information that enables computing platform(s) 102 to function as described herein.

Processor(s) 124 may be configured to provide information processing capabilities in computing platform(s) 102. As such, processor(s) 124 may include one or more of a digital processor, an analog processor, a digital circuit designed to process information, an analog circuit designed to process information, a state machine, and/or other mechanisms for electronically processing information. Although processor(s) 124 is shown in FIG. 1 as a single entity, this is for illustrative purposes only. In some implementations, processor(s) 124 may include a plurality of processing units. These processing units may be physically located within the same device, or processor(s) 124 may represent processing functionality of a plurality of devices operating in coordination. Processor(s) 124 may be configured to execute modules 108, 110, 112, 114, 116, and/or 118, and/or other modules. Processor(s) 124 may be configured to execute modules 108, 110, 112, 114, 116, and/or 118, and/or other modules by software; hardware; firmware; some combination of software, hardware, and/or firmware; and/or other mechanisms for configuring processing capabilities on processor(s) 124. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 108, 110, 112, 114, 116, and/or 118 are illustrated in FIG. 1 as being implemented within a single processing unit, in implementations in which processor(s) 124 includes multiple processing units, one or more of modules 108, 110, 112, 114, 116, and/or 118 may be implemented remotely from the other modules. The description of the functionality provided by the different modules 108, 110, 112, 114, 116, and/or 118 described below is for illustrative purposes, and is not intended to be limiting, as any of modules 108, 110, 112, 114, 116, and/or 118 may provide more or less functionality than is described. For example, one or more of modules 108, 110, 112, 114, 116, and/or 118 may be eliminated, and some or all of its functionality may be provided by other ones of modules 108, 110, 112, 114, 116, and/or 118. As another example, processor(s) 124 may be configured to execute one or more additional modules that may perform some or all of the functionality attributed below to one of modules 108, 110, 112, 114, 116, and/or 118.

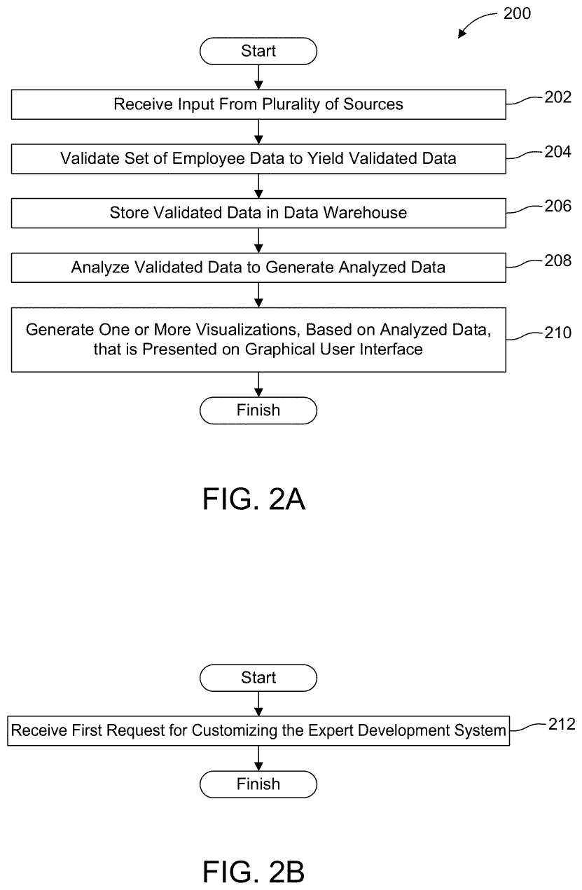

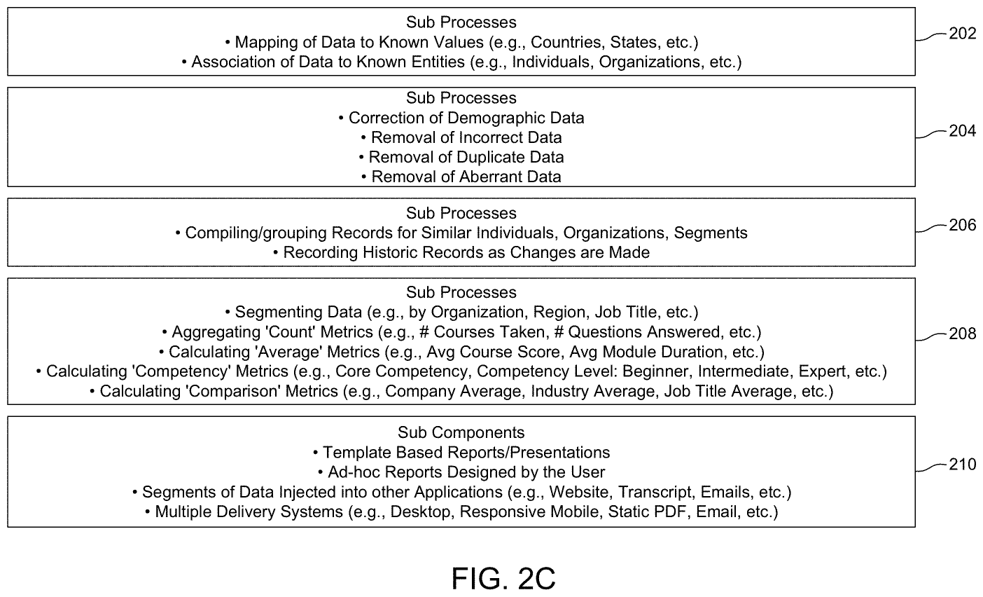

FIGS. 2A and/or 2B illustrates a method 200 implemented by an expert development system, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIGS. 2A and/or 2B and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

FIG. 2A illustrates method 200, in accordance with one or more implementations.

An operation 202 may include receiving input from a plurality of sources. The input may include employee data for each of a plurality of employees to yield a set of employee data. The plurality of sources may include one or more chapters, courses, standards development organizations, conferences or expositions, memberships, foundations, cable and internet protocol games, certifications, websites, applications, leadership institutes, human resource databases and systems, and partner information. Operation 202 may be performed by one or more hardware processors configured by machine-readable instructions including a module that is the same as or similar to input receiving module 108, in accordance with one or more implementations.

An operation 204 may include validating the set of employee data to yield validated data. Operation 204 may be performed by one or more hardware processors configured by machine-readable instructions including a module that is the same as or similar to set validation module 110, in accordance with one or more implementations.

An operation 206 may include storing the validated data in a data warehouse. Operation 206 may be performed by one or more hardware processors configured by machine-readable instructions including a module that is the same as or similar to data storing module 112, in accordance with one or more implementations.

An operation 208 may include analyzing the validated data to generate analyzed data. The analyzed data may include one or more alerts, reports, and dashboards. Operation 208 may be performed by one or more hardware processors configured by machine-readable instructions including a module that is the same as or similar to data analysis module 114, in accordance with one or more implementations.

An operation 210 may include generating one or more visualizations, based on the analyzed data, which is presented on a graphical user interface. Operation 210 may be performed by one or more hardware processors configured by machine-readable instructions including a module that is the same as or similar to visualization generating module 116, in accordance with one or more implementations.

FIG. 2B illustrates a possible continuation of method 200, in accordance with one or more implementations.

An operation 212 may include further including receiving a first request. The first request may relate to customizing the expert development system, such as submitting a request (e.g., the expert development system receiving a request from a user, partner, company, individual, etc.). The request may customize the analysis, generating, and or other aspects of the method of 200. The first request may include an indication of a first analysis and first visualization. The analyzing and generating one or more visualizations may be customized based on the first request. Operation 212 may be performed by one or more hardware processors configured by machine-readable instructions including a module that is the same as or similar to request receiving module 118, in accordance with one or more implementations.

FIG. 2C. illustrates a possible continuation of method 200, in accordance with one or more implementations.

An operation 202 may include one or more subprocesses. For example, operation 202 may include mapping of data to known values (e.g., countries, states, etc.). For example, operation 202 may include the association of data to known entities (e.g., individuals, organizations, etc.). Operation 202 may be performed by one or more hardware processors configured by machine-readable instructions including a module that is the same as or similar to set validation module 110, in accordance with one or more implementations.

An operation 204 may include one or more subprocesses. For example, operation 204 may include the correction of demographic data. For example, operation 204 may include removal of incorrect data. For example, operation 204 may include the removal of duplicate data. For example, operation 204 may include the removal of aberrant data. Operation 204 may be performed by one or more hardware processors configured by machine-readable instructions including a module that is the same as or similar to set validation module 110, in accordance with one or more implementations.

An operation 206 may include one or more subprocesses. For example, operation 206 may include compiling/grouping records for similar individuals, organizations, and/or segments. For example, operation 206 may include recording historic records as changes are made. Operation 206 may be performed by one or more hardware processors configured by machine-readable instructions including a module that is the same as or similar to set validation module 110, in accordance with one or more implementations.

An operation 208 may include one or more subprocesses. For example, operation 208 may include segmenting data (e.g., by Organization, Region, Job Title, etc.). For example, operation 208 may include aggregating ‘Count” metrics (e.g., # courses taken, # questions answered, etc.). For example, operation 208 may include calculating ‘Average’ metrics (e.g., avg course score, avg module duration, etc.). For example, operation 208 may include calculating ‘Competency’ metrics (e.g., core competency, competency level: beginner, intermediate, expert, etc.). For example, operation 208 include calculating ‘Comparison’ metrics (e.g., company average, industry average, job title average, etc.). Operation 208 may be performed by one or more hardware processors configured by machine-readable instructions including a module that is the same as or similar to set validation module 110, in accordance with one or more implementations.

An operation 210 may include one or more subprocesses. For example, operation 210 may include generating template-based reports/presentations. For example, operation 210 may include generating Ad-hoc reports designed by the user. For example, operation 210 may include generating segments of data injected into other Applications (e.g., website, transcript, emails, etc.). For example, operation 210 may include processing/sending data into Multiple Delivery Systems (e.g., desktop, responsive mobile, static PDF, email, etc.). Operation 210 may be performed by one or more hardware processors configured by machine-readable instructions including a module that is the same as or similar to set validation module 110, in accordance with one or more implementations.

An operation 202 may include one or more subprocesses. Operation 202 may be performed by one or more hardware processors configured by machine-readable instructions including a module that is the same as or similar to set validation module 110, in accordance with one or more implementations

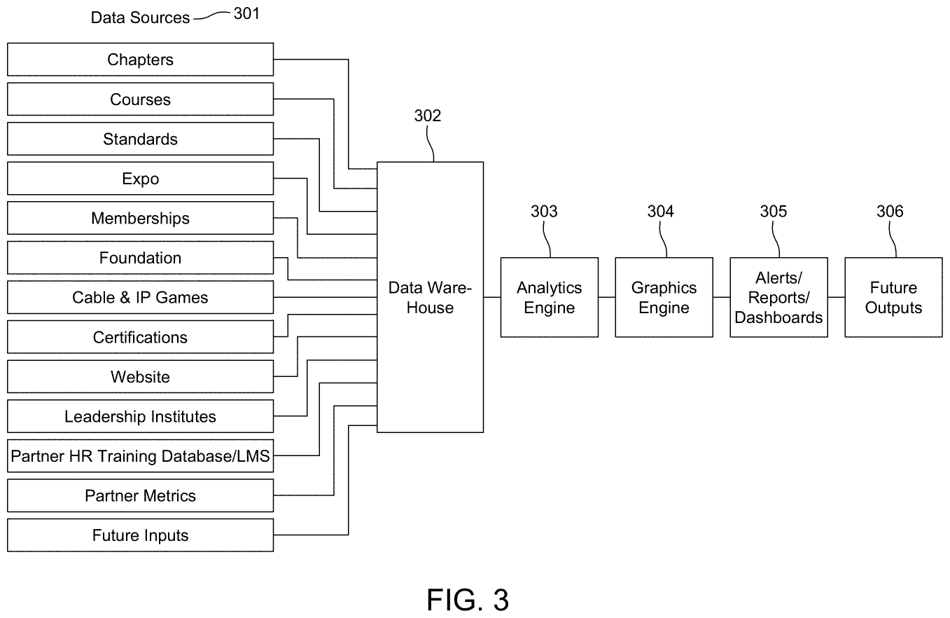

FIG. 3 is a process flow, showing inputs, storage, analysis, and outputs according to one or more embodiments described herein. In one example, FIG. 3 may be representative of an expert development system flow. The expert development system may comprise a system of networked devices, computers, and the like. In one example, the elements as shown in FIG. 3 may be included in the expert development system as individual pieces of hardware, networked components, software modules, or the like. Element 301 may be an example selection of sources of data. For example, sources may include chapters, courses, standards, expos, memberships, foundations, cable and IP games, certifications, websites, leadership institutes, partner HR training databases/LMS, partner metrics, key performance indicators, future inputs, and/or any other sources mentioned herein. Element 302 may be a data warehouse that stores, aggregates, pulls, receives, and/or generates data from the sources. Element 303 may be an analytics engine that has access to, and uses, data from the data warehouse. The analytics engine may process data according to one or more technique described herein. Element 304 may be a graphics engine that uses the results from the analysis engine, and/or raw data from the data warehouse to create/generate alerts/reports/dashboards; the graphics engine may use one or more techniques described herein. Element 305 may be alerts, reports, and/or dashboards generated from the graphics engine and/or directly pulled from the data warehouse; there may be one or more other aspects to alerts, reports, and/or dashboards as disclosed herein. Element 306 may be reserved for future outputs.

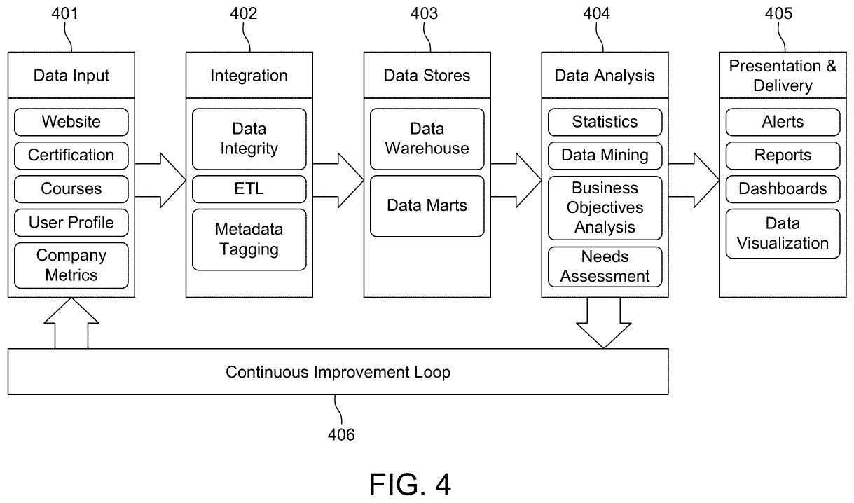

FIG. 4 is a process flow, showing how data flows from input to output according to one or more embodiments described herein. For example, at 401 there may be data input (e.g., website, certification, courses, user profiles, company metrics, etc.). At 402, the inputted data may be integrated (e.g., checking data integrity, ETL, meta data tagging, etc.). At 403, integrated data may be stored in data warehouse and/or a data mart. At 404, data analysis may be performed (e.g., statistics, data mining, business objective analysis, needs assessment, etc.). Steps 401-404 may be repeated, in part or in its entirety, as needed or as desired. The repetition, shown as 406, may be a continuous improvement loop, where data is continually being improved on thereby enabling the system to provide for real-time, almost real-time, dynamically adjustable, data that can be used for one or more steps/techniques disclosed herein (e.g., presenting the data). At 405, the analyzed data may be used for presentation and/or delivery (e.g., alerts, reports, dashboards, data visualization, and the like).

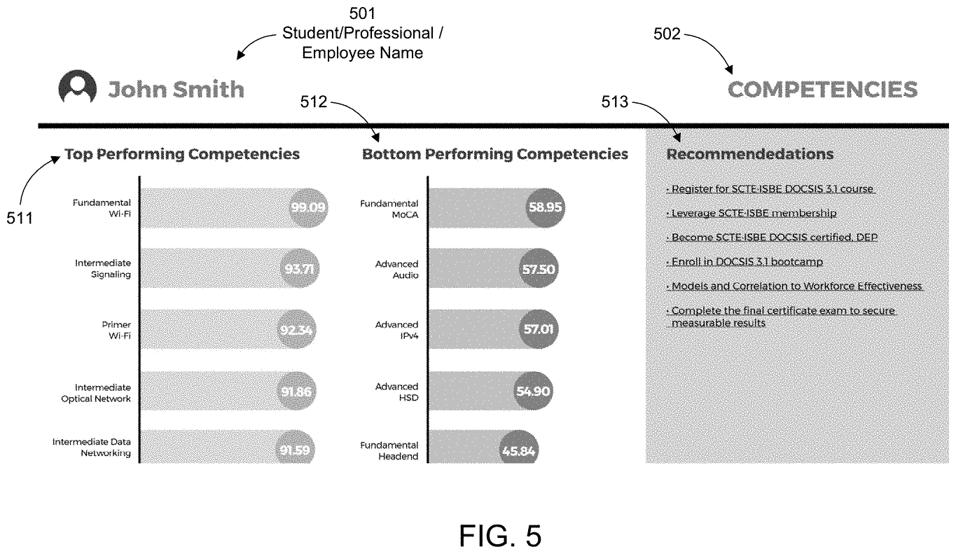

FIG. 5 is an example diagram showing the results of data analysis according to one or more embodiments disclosed herein, such as alerts, reports, and dashboards regarding individual employee competencies presented in a visualization. For a given employee there may be a list of top performing competencies and bottom performing competencies. For a given employee there may be recommendations to address the top and bottom performing competencies. For example, at 501 an employee name may be listed (e.g., employee, student, professional, etc.). At 502, the competencies may be indicated as the purpose of the presentation (e.g., report, page, site, etc.). At 511, the top performance competencies may be shown. At 512, the bottom performing competencies may be shown. At 513, recommendations may be shown that are based on the known competency information. Any aspect of FIG. 5 may also be representative of techniques that may be performed by the analysis engine.

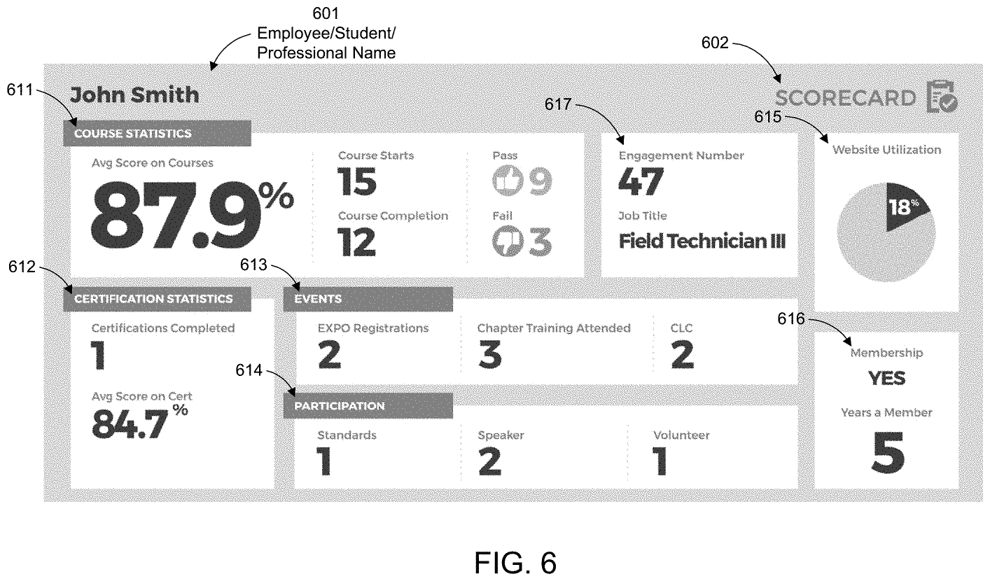

FIG. 6 is an example diagram showing the results of data analysis according to one or more embodiments disclosed herein, such as alerts, reports, and dashboards regarding an individual employee scorecard with statistics presented in a visualization. For a given employee scorecard there may be course statistics, certification statistics, event statistics, participation statistics, engagement statistics, membership information, and other related information. At 602, the particular type of presentation may be identified, such as a scorecard. At 601, the professional may be identified. At 611 course statistics about the professional may be shown, where various details about one or more courses may be presented. At 612, certification statistics for the professional may be presented. At 613, events that the professional has attended and/or is registered for may be presented. At 614, participation information about the professional may be presented. At 616, other information about the professional may be presented (e.g., membership information). At 615, website utilization about the professional may be presented.

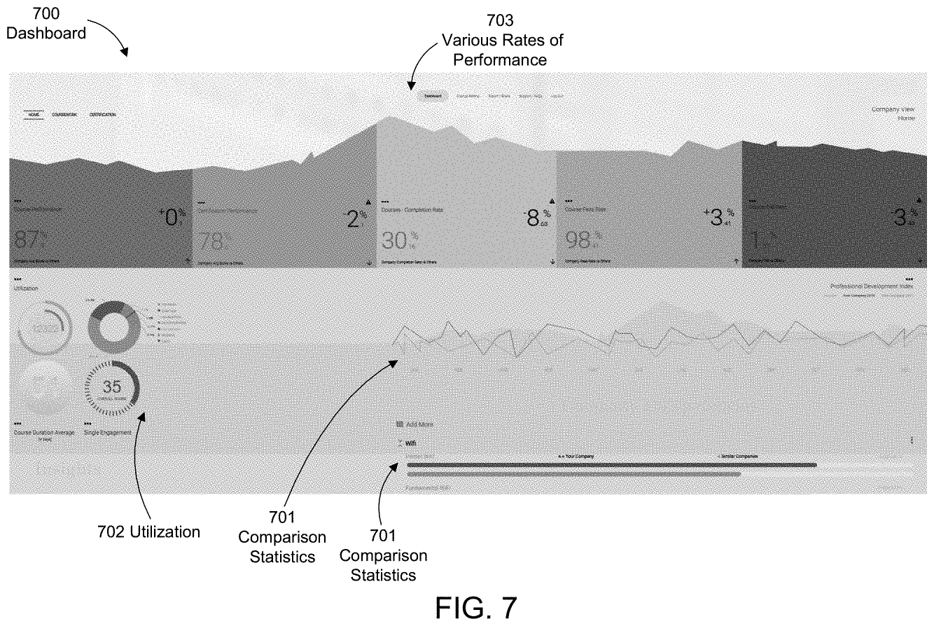

FIG. 7 is an example diagram showing the results data analysis according to one or more embodiments disclosed herein, such as a dashboard presented in a visualization. A dashboard may include statistics, such as those disclosed in relation to FIG. 6, and present the statistics in a visualized manner (e.g., graphs, charts, dynamic graphics, etc.). 700 is an example of a dashboard. 703 shows various rates of performances accompanied by graphical presentation of the underlying numerical values. 701 shows comparison statistics, where different line types (e.g., shades of a color, dashed or solid lines, etc.) indicated different companies' information being compared. 702 shows utilization information.

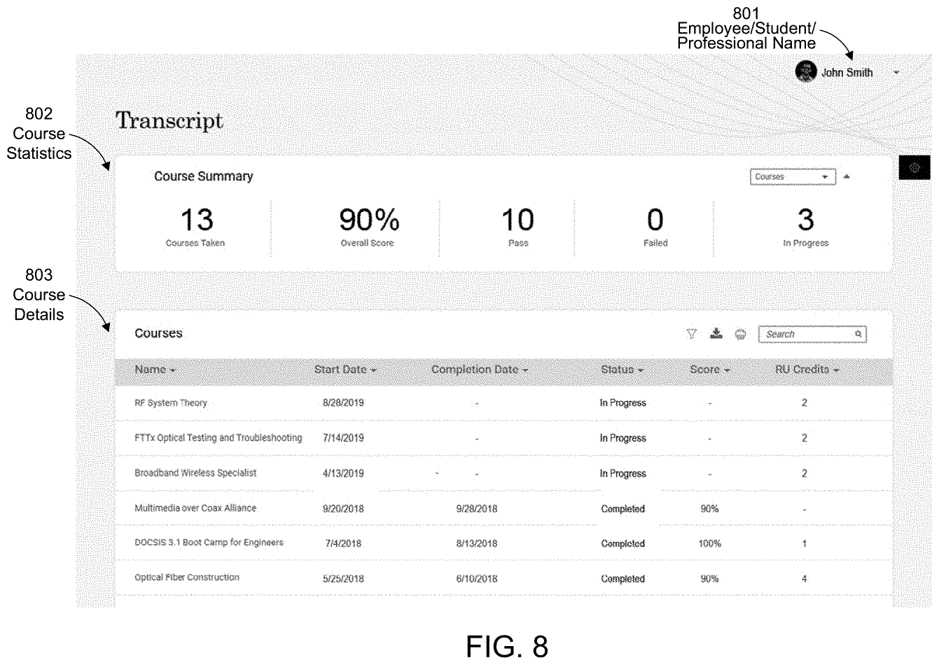

FIG. 8 is an example diagram showing the results data analysis according to one or more embodiments disclosed herein, such as alerts, reports, and dashboards regarding an individual employee a transcript. The transcript may be generated based on the analyzed data and show, for example, all of the courses the employee has completed, dates of starting and completing, class score, and class credits. At 801, a professional's name may be displayed. At 802, course statistic information may be displayed. At 803, course details may be displayed.

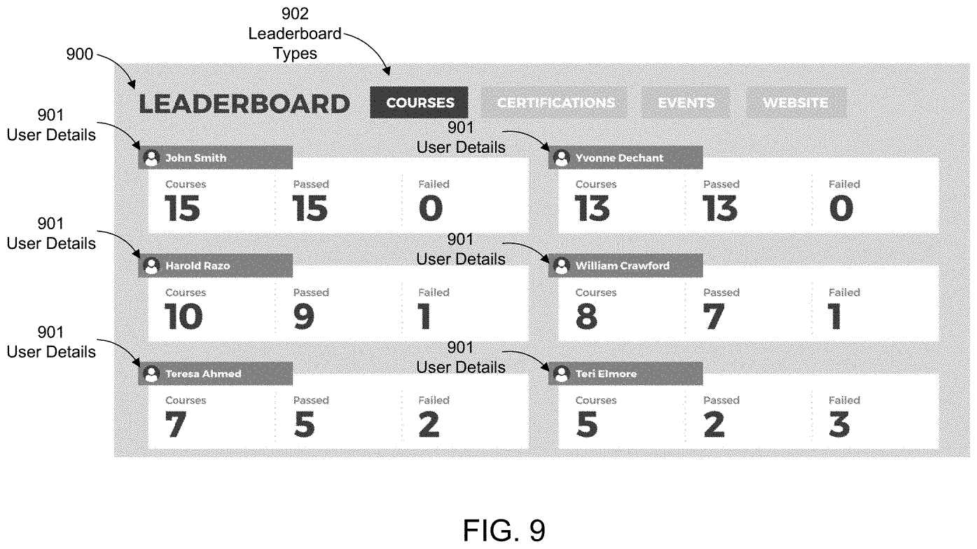

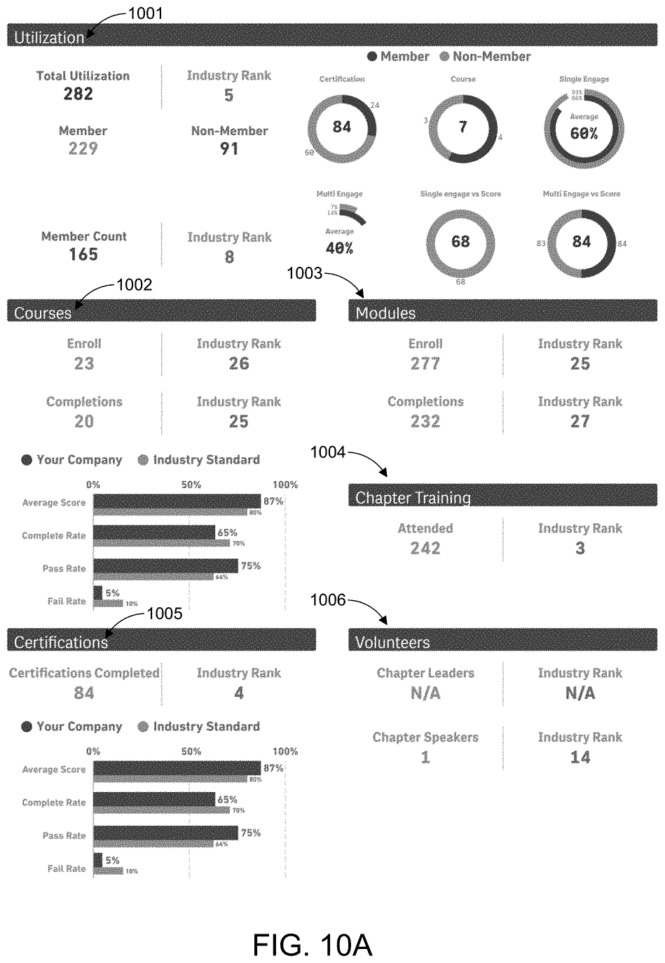

FIG. 9 is an example diagram showing the results data analysis according to one or more embodiments disclosed herein, such as alerts, reports, and dashboards regarding a leaderboard presented in a visualization. A leaderboard may show, for example, who has completed the most courses or certifications, who has attended the most events, and who has most utilized the website. 900 may be an example of a leaderboard. There may be more than one type of leaderboard, as shown at 902. A leaderboard 900 may present the professionals who are leading a given type of assessment (e.g., courses, certifications, event attendance, website participation, etc.). The user details may be shown as pointed out at 901.

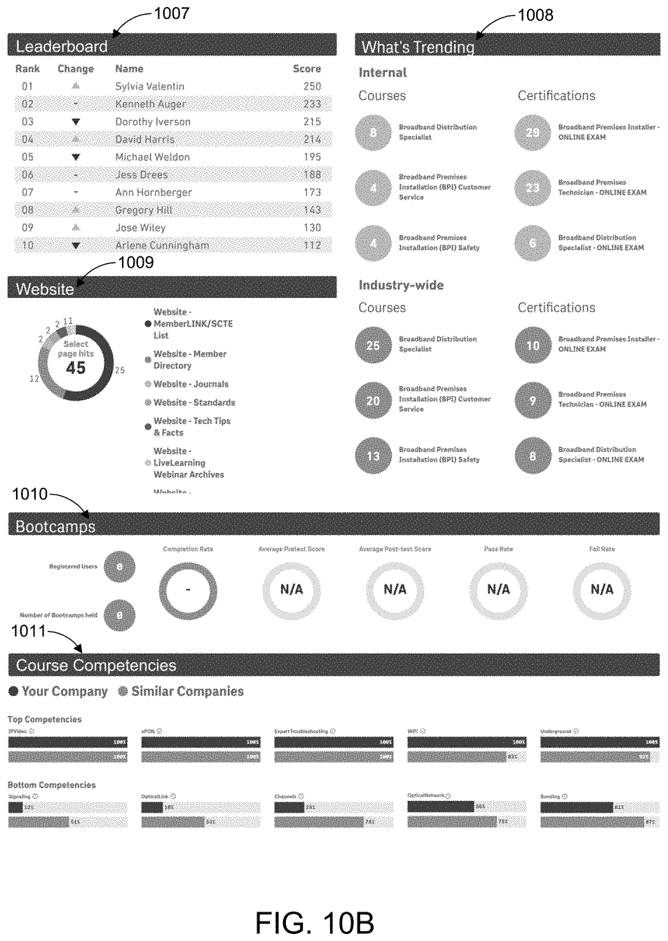

FIG. 10A is an example diagram showing the results of data analysis according to one or more embodiments disclosed herein, such as alerts, reports, and dashboards that include various visualizations. Utilization 1001 may include total utilization, member and non-member information, industry rank(s), engagement, certification, and other pieces of visualized information related to utilization 1001. Courses 1002 may include enrollment, completion(s), industry rank(s), comparisons (e.g., a first company versus a second company), average scores, completion rates, pass rates, failure rates, and other pieces of visualized information related to courses 1002. Modules 1003 may include visualized information such as enrollment, completions, industry rank, and other pieces of visualized information related to modules 1003. Chapter training 1004 may include attendance, industry rank, and other pieces of visualized information related to chapter training 1004. Certifications 1005 may include completion(s), industry rank(s), comparisons (e.g., a first company versus a second company), average scores, completion rates, pass rates, failure rates, and other pieces of visualized information related to certifications 1005. Volunteers 1006 may include chapter leaders, industry rank, chapter speakers, industry rank, and other pieces of visualized information related to volunteers 1006.

FIG. 10B is an example diagram showing the results data analysis according to one or more embodiments disclosed herein, such as alerts, reports, and dashboards that include various visualizations. Leaderboard 1007 may include rank, change, name, and score information for one or more company. What's Trending 1008 may include internal trends (e.g., internal to a specific company), and/or industry wide trends; also, the trends may relate to courses, certification, and the like. Website 1009 may include website related information, such as page hits broken down by categories. Bootcamps 1010 may include registered users, number of boot camps held, completion rates, pre-test scores, average post-test scores, pass rate, fail rates, and other pieces of visualized information related to boot camps 1010. Course competencies 1011 may include comparison information (e.g., a first company versus a second company), top competencies, bottom competencies, and other pieces of visualized information related to course competencies 1011.

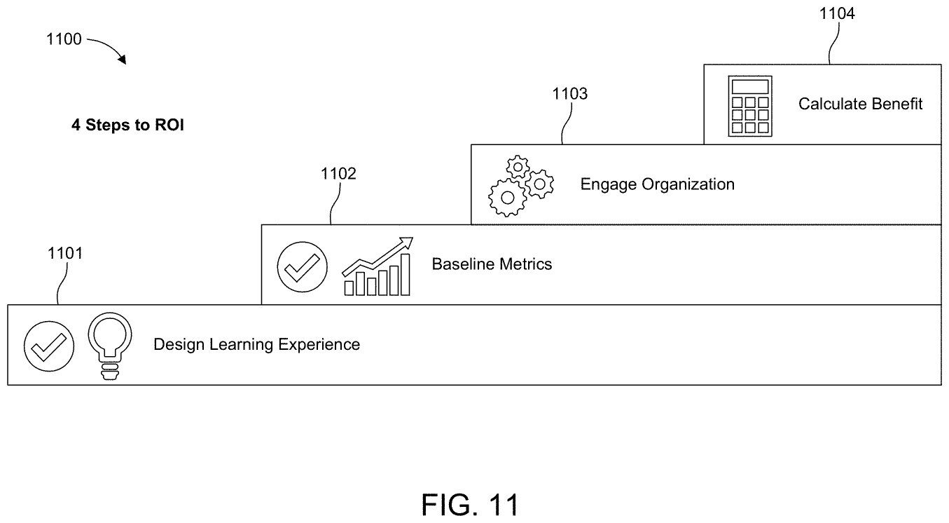

FIG. 11 illustrates four steps necessary for a company to realize a return on investing in learning and development. From a generalized perspective, return on investment may be determined based on 1101 designing learning experiences, 1102 acquiring baseline metrics, 1103 engaging an organization, and/or 1104 calculating the potential return on investment if made (e.g., benefit of using an expert system, according to one or more embodiments disclosed herein, etc.).

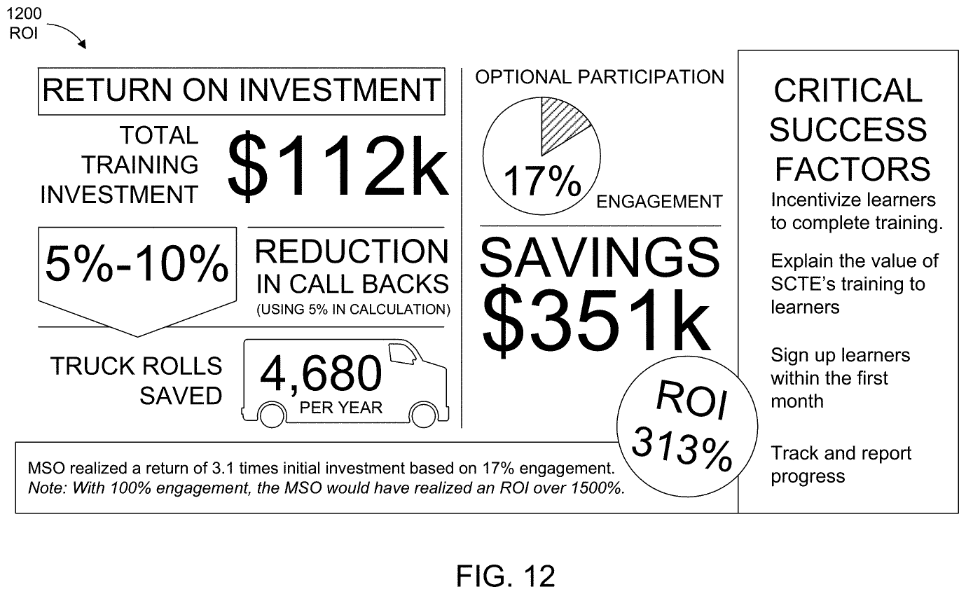

FIG. 12 is an example diagram showing the results data analysis according to one or more embodiments disclosed herein, such as alerts, reports, and dashboards regarding a return on investment in a visualization. A customized report regarding a return on investment may show a number of facts determined from the analyzed data, such as total training amount, reduction in call backs, truck rolls saved, overall savings, optional participation, and critical success factors for achieving the return on investment. 1200 is an example ROI presentation with detailed information related to the use of an expert development system.

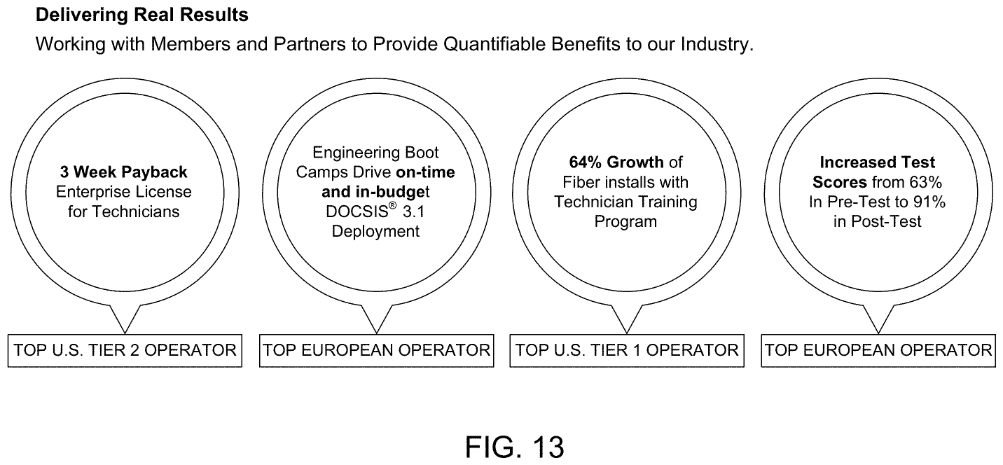

FIG. 13 is an example diagram showing the results data analysis according to one or more embodiments disclosed herein, such as alerts, reports, and dashboards regarding executive summaries in a visualization. A customized report designed to be presented to corporate executive members may contain summaries of their membership, the benefits of being a member, and overall operational information as it relates to the expert development system.

In an exemplary embodiment, there may be a method implemented by an expert development system. The method may comprise one or more of the following steps: receiving input from a plurality of sources, the input comprising employee data for each of a plurality of employees to yield a set of employee data, wherein the plurality of sources comprises one or more chapters, courses, standards development organizations, conferences or expositions, memberships, foundations, cable and internet protocol games, certifications, websites, applications, leadership institutes, human resource databases and systems, and partner information; validating the set of employee data to yield validated data; storing the validated data in a data warehouse; analyzing the validated data to generate analyzed data, wherein the analyzed data includes one or more alerts, reports, and dashboards; and/or, generating one or more visualizations, based on the analyzed data, that is presented on a graphical user interface. The expert development system may be a computing platform configured that comprises: a non-transient computer-readable storage medium having executable instructions embodied thereon; and one or more hardware processors configured to execute the instructions that carry out the aforementioned method.

One aspect of the present disclosure relates to a method implemented by an expert development system. The method may include receiving input from a plurality of sources. The input may include employee data for each of a plurality of employees to yield a set of employee data. The plurality of sources may include one or more chapters, courses, standards development organizations, conferences or expositions, memberships, foundations, cable and internet protocol games, certifications, websites, applications, leadership institutes, human resource databases and systems, key performance indicators, and partner information. The method may include validating the set of employee data to yield validated data. The method may include storing the validated data in a data warehouse. The method may include analyzing the validated data to generate analyzed data. The analyzed data may include one or more alerts, reports, and dashboards. The method may include generating one or more visualizations, based on the analyzed data, which is presented on a graphical user interface.

In some implementations of the method, each chapter may include a group of individuals in a geographic region. In some implementations of the method, the members may meet on a regular basis to conduct training classes, practice technical skills, and socially network with other individuals in an industry.

In some implementations of the method, data that is input into the data warehouse may be tagged with metatags. In one example, there may be a competency tag associated with each piece of data. In some cases, the competency may be associated with an employee/professional of a company, and in some cases the competency may be associated with a company. This tagging may enable the expert development system to provide competency assessments, rankings, and other related reports of employees and/or companies for competencies about specific subjects.

In some implementations of the method, competency tags may have different levels. In one example, there may be at least three levels of competency, such as beginner, middle, and expert. In one example, each level of a competency may relate to an employee's competency as determined by other inputs acquired and stored in the data warehouse (e.g., as disclosed herein). Competency tags may be subject specific or subject agnostic.

In some implementations of the method, one or more key performance indicators received from a company may be used in the analysis step/engine to assess whether or not company-based goals are being achieved, which in turn may allow the expert development system to better assess the return on investment for a given company.

In some implementations of the method, each chapter may collect information regarding each individual of the chapter. In some implementations of the method, each chapter may generate input based on the collected information including individuals of the chapter, an active or inactive status of each individual, training activities conducted by the chapter, skills competitions conducted by the chapter, people who have presented at an activity at the chapter, and people who volunteers as a leader within the chapter.

In some implementations of the method, each course may include a training opportunity that individuals select to learn and master new technical skills.

In some implementations of the method, each course may generate input including all courses created by an organization, student profiles, student names, student birthdates, student companies, student progress for each course, student performance evaluations, and student competencies.

In some implementations of the method, each standards development organization may develop, update, and promulgate standards and operating practices that speed up an introduction of innovative products to a market and expedite adoption and deployment in an industry.

In some implementations of the method, each standards development organization may generate input including all standards and operating practices created by the standards development organization, standards development organization member profiles, and standards development membership organization activities that contribute to creating the standards and operating practices.

In some implementations of the method, each conference or exposition may be a periodic industry gathering that showcases technical developments in an industry with presentations of technical papers, demonstrations of technologies and equipment, meetings for technical exchange, and social networking.

In some implementations of the method, each conference or exposition may generate input including attendees, exhibitors, sponsors, competition winners, and technical papers.

In some implementations of the method, each membership may include either an individual membership or a company membership. In some implementations of the method, the company membership may provide an enterprise license for the company's employees. In some implementations of the method, the individual membership or the company membership may receive discounted pricing to training, standards related material, conferences, and membership only events.

In some implementations of the method, each membership may generate input including member name, member address, member company, member start date, member expiration date, and member exclusive events.

In some implementations of the method, each foundation may be a philanthropic organization that funds training of individuals who have financial hardship.

In some implementations of the method, each foundation may generate input information, for example, including information regarding members of a foundation, members of management board of the foundation, and individuals that have received funding from the foundation.

In some implementations of the method, each cable and IP game may be a learning and development tool wherein participants demonstrate learned skills and compete for recognition and prizes.

In some implementations of the method, each cable and IP game may generate input including games offered over a period of time, each game a participant has played, and each score of each game a participant has played.

In some implementations of the method, each certification may be specific to a technical field and certifies that an individual has completed a set of courses and passed an examination of each of the set of courses thereby demonstrating the individual's mastery in the technical field and resulting in the individual receiving a certification.

In some implementations of the method, each certification may generate input including a list of certifications, a list of individuals and any certifications they have received, a list of individuals and a date they received any certification, a list of individuals and a progress in any certification, and a list of individuals and a date of any required recertification.

In some implementations of the method, the graphical user interface may include at least one website or application for the expert development system.

In some implementations of the method, the website or application may generate input including information gathered from users or visitors of the website or application.

In some implementations of the method, each leadership institute may include a collaboration between industry and academic partners focused on developing leaders in industry.

In some implementations of the method, each leadership institute may generate input including institute attendees, institute topics, institute alumni, and institute professors and speakers.

In some implementations of the method, each human resource database and system may be a collection of information from a company's employees.

In some implementations of the method, each human resource database and system may generate input including employee information, individual information, employee competencies, individual competencies, employee achievements, individual achievements, employee transcripts, or individual transcripts. As discussed herein, reference to employee or individual may be interchangeable.

In some implementations of the method, each partner may include a company that has access to the expert development system.

In some implementations of the method, each partner may generate input including information unique to the company or organization.

In some implementations of the method, each partner may be categorized as either a skills-based partner or a standards based partner. In some implementations of the method, each partner may be a telecommunications multi-system operator, a telecommunications equipment vendor, a telecommunications service vendor, or a standards contributor.

In some implementations of the method, the expert development system may include one or more computers.

In some implementations of the method, storing the validated data may further include reformatting all data to a standardized format.

In some implementations of the method, the analyzing may be performed using one or more techniques, the one or more techniques including machine learning, statistical analysis, data mining, business objective analysis, return on investment analysis, or needs assessing.

In some implementations of the method, the analyzing may be performed by an analytics engine.

In some implementations of the method, the analysis may result in recommendation(s) to the professional and/or the company. The recommendation may be based on the analysis of the data in the data warehouse, and/or any input into the system. The recommendations may be displayed with other analysis information that is related to the recommendations using the graphics engine.

In some implementations of the method, the one or more visualizations may include charts, graphs, lists, spreadsheets, graphically arranged text, and animations.

In some implementations of the method, the analyzing may be performed by an analytics engine. In some implementations of the method, the visualizations may be performed by a graphics engine. In some implementations of the method, the graphics engine may be part of the analytics engine.

In some implementations of the method, the analyzed data may further include employee performance in key areas.

In some implementations of the method, analyzed data may further include patterns or trends that are not determinable from a single source.

In some implementations of the method, the analyzed data may further include a score card.

In some implementations of the method, each employee may be incentivized to achieve a higher score on a score card.

In some implementations of the method, analyzing the validated data may further include tagging each employee of the plurality of employees with a set of competencies.

In some implementations of the method, analyzing the validated data may further include tagging each employee of the plurality of employees with a gap assessment.

In some implementations of the method, analyzing the validated data may further include calculating a return on investment that indicates how soon an individual or company will be paid back for investing in an activity or group of activities.

In some implementations of the method, the dashboard may show one or more visualizations for a period of time regarding one or more activities, one or more employees, or one or more corporations.

In some implementations of the method, the dashboard may show one or more visualizations for a period of time regarding one or more activities, one or more employees, or one or more corporations. In some implementations of the method, each activity may be associated or displayed with a competency.

In some implementations of the method, a report may be specific to one of the plurality of sources and includes competencies and recommendations determined based on the analyzed data.

In some implementations of the method, a report may include information on a gap between competencies a company requires and competencies an employee possesses, and where the report further includes a method to fill the gap through training or other skills development.

In some implementations of the method, a report may include a return-on-investment assessment summary.

In some implementations of the method, the employee data may include a transcript specific to a single employee and contains information from more than one source of the plurality of sources.

In some implementations of the method, the analyzed data may include a leader board showing a ranked list of high performing employees of the plurality of employees. In some implementations of the method, the leaderboard also may include information about the high performing employees.

In some implementations of the method, each employee data may include elements relating to at least one of learning and professional development, certifications, standards development, professional engagements, and teaching engagements.

In some implementations of the method, it may include receiving a first request. In some implementations of the method, the first request may include an indication of a first analysis and first visualization. In some implementations of the method, the analyzing and generating one or more visualizations may be customized based on the first request.

Another aspect of the present disclosure relates to a computing platform configured implemented by an expert development system. The computing platform may include a non-transient computer-readable storage medium having executable instructions embodied thereon. The computing platform may include one or more hardware processors configured to execute the instructions. The processor(s) may execute the instructions to receive input from a plurality of sources. The input may include employee data for each of a plurality of employees to yield a set of employee data. The plurality of sources may include one or more chapters, courses, standards development organizations, conferences or expositions, memberships, foundations, cable and internet protocol games, certifications, websites, applications, leadership institutes, human resource databases and systems, and partner information. The processor(s) may execute the instructions to validate the set of employee data to yield validated data. The processor(s) may execute the instructions to store the validated data in a data warehouse. The processor(s) may execute the instructions to analyze the validated data to generate analyzed data. The analyzed data may include one or more alerts, reports, and dashboards. The processor(s) may execute the instructions to generate one or more visualizations, based on the analyzed data, which is presented on a graphical user interface.

Yet another aspect of the present disclosure relates to a non-transient computer-readable storage medium having instructions embodied thereon, the instructions being executable by one or more processors to perform a method implemented by an expert development system. The method may include receiving input from a plurality of sources. The input may include employee data for each of a plurality of employees to yield a set of employee data. The plurality of sources may include one or more chapters, courses, standards development organizations, conferences or expositions, memberships, foundations, cable and internet protocol games, certifications, websites, applications, leadership institutes, human resource databases and systems, and partner information. The method may include validating the set of employee data to yield validated data. The method may include storing the validated data in a data warehouse. The method may include analyzing the validated data to generate analyzed data. The analyzed data may include one or more alerts, reports, and dashboards. The method may include generating one or more visualizations, based on the analyzed data, which is presented on a graphical user interface.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. An expert development system, comprising:
one or more processors;
at least one non-transient computer-readable storage medium having instructions thereon, the instructions being executed by the one or more processors that causes the processor to:
receive input from a plurality of sources, the input comprising employee data for each of a plurality of employees to yield a set of employee data;
validate the set of employee data to yield validated data, wherein in the instructions to validate includes instructions for adding meta tags;
store the validated data in a data warehouse;
analyze the validated data to generate analyzed data, wherein the analyzed data includes one or more alerts, reports, and dashboards;
generate one or more visualizations, based on the analyzed data, that is presented on a graphical user interface of the expert development system, wherein the virtualizations include the one or more alerts, reports, and dashboards.

2. The expert development system of claim 1, wherein the plurality of sources comprises one or more chapters, courses, standards development organizations, conferences or expositions, memberships, foundations, cable and internet protocol games, certifications, websites, applications, leadership institutes, human resource databases and systems, and partner information

3. The expert development system of claim 1, wherein the graphical user interface comprises at least one website for the expert development system.

4. The expert development system of claim 3, wherein the website generates input comprising information gathered from users or visitors of the website.

5. The expert development system of claim 1, wherein storing the validated data further includes reformatting all data to a standardized format.

6. The expert development system of claim 1, wherein the analyzing is performed using a plurality of techniques, the plurality of techniques comprising machine learning, statistical analysis, data mining, business objective analysis, return on investment analysis, and needs assessing.

7. The expert development system of claim 1, wherein the one or more visualizations includes charts, graphs, lists, spreadsheets, graphically arranged text, and animations.

8. The method of claim 1, wherein the analyzing is performed by an analytics engine, the visualizations are performed by a graphics engine.

9. The expert development system of claim 1, wherein analyzing the validated data further includes tagging each employee of the plurality of employees with a set of competencies.

10. The expert development system of claim 1, wherein analyzing the validated data further includes tagging each employee of the plurality of employees with a gap assessment.

11. The expert development system of claim 1, wherein analyzing the validated data further includes calculating a return on investment that indicates how soon an individual or company will be paid back for investing in an activity or group of activities.

12. The expert development system of claim 1, wherein the dashboard shows information regarding a period of time of one or more activities, one or more employees, and one or more corporations.

13. The expert development system of claim 1, wherein a report is specific to one of the plurality of sources and includes competencies and recommendations determined based on the analyzed data.

14. The expert development system of claim 1, wherein a report includes information on a gap between competencies a company requires and competencies an employee possesses, and wherein the report further includes a method to fill the gap through a specific training or other skills development activity as determined by an analytics engine.

15. The expert development system of claim 1, wherein a report includes a return-on-investment assessment summary.

16. A method implemented by an expert development system, comprising:
receiving input from a plurality of sources, the input comprising employee data for each of a plurality of employees to yield a set of employee data;
validating the set of employee data to yield validated data, wherein in the instructions to validate includes instructions for adding meta tags;
storing the validated data in a data warehouse;
analyzing the validated data to generate analyzed data, wherein the analyzed data includes one or more alerts, reports, and dashboards;
generating one or more visualizations, based on the analyzed data, that is presented on a graphical user interface of the expert development system, wherein the virtualizations include the one or more alerts, reports, and dashboards.

17. The method of claim 16, wherein the plurality of sources comprises one or more chapters, courses, standards development organizations, conferences or expositions, memberships, foundations, cable and internet protocol games, certifications, websites, applications, leadership institutes, human resource databases and systems, and partner information

18. The method of claim 16, wherein the graphical user interface comprises at least one website for the expert development system.

19. The method of claim 18, wherein the website generates input comprising information gathered from users or visitors of the website.

20. The method of claim 16, wherein storing the validated data further includes reformatting all data to a standardized format.
